(19) United States
(12) Patent Application Publication
(10) Pub. No.: US 2026/0194878 A1
(43) Pub. Date: Jul. 9, 2026

(54) CONTROL DEVICE FOR MACHINE TOOL

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/131,523

(22) PCT Filed: Nov. 30, 2022
(86) PCT No.: PCT/JP2022/044216

§ 371 Date: May 20, 2025

(51) Int. Cl. G05B 19/042

(52) U.S. Cl. CPC G05B 19/042; G05B 2219/23186

(57) ABSTRACT

Provided is a technology that enables a processing program to be easily set, and enables air cutting to be reliably executed in a control device for a machine tool that controls thread cutting with and without oscillation. The control device 1 for a machine tool comprises: a cutting position acquisition unit 11 that acquires a cutting position for thread cutting; a margin acquisition unit 12 that acquires a margin set so that the cutting tool oscillates beyond the cutting position in thread cutting with oscillation; an oscillation amplitude information acquisition unit 13 that acquires oscillation amplitude information indicating the oscillation amplitude of the thread cutting with oscillation; and a thread cutting command generation unit 20 that generates a thread cutting command to oscillate so that at least one end position in the oscillation direction exceeds the cutting position on the basis of the cutting position, the margin, and the oscillation amplitude information.

### TECHNICAL FIELD

The present disclosure pertains to a control device for a machine tool.

### BACKGROUND ART

Conventionally, with a machine tool, oscillation machining for causing a tool and a workpiece to oscillate relatively is performed in order to avoid a situation such as where chips that continuously occur when machining get entangled in a workpiece or cutting tool and thus become a cause of a machining defect, a machine failure, or the like (for example, refer to Patent Document 1 and Patent Document 2).

In this kind of oscillation machining, setting is performed such that a tool route, which is the path for the tool, partially overlaps with a previous tool route, whereby non-contact motion referred to as air cutting in which the tool moves away from the surface of the workpiece is caused to occur, and the chips are shredded.

### CITATION LIST

### Patent Document

Patent Document 1: Japanese Unexamined Patent Application, Publication No. 2020-124793
Patent Document 2: PCT International Publication No. WO2016/067372

### DISCLOSURE OF THE INVENTION

### Problems to be Solved by the Invention

Incidentally, thread cutting is performed as a set of machining that has oscillation and machining that does not have oscillation. In a case of performing both of machining that has oscillation and machining that does not have oscillation, cutting positions are often designated to be the same position (for example, a position along the X axis) from a perspective of simplifying a machining program.

However, in a case of executing oscillation thread cutting such that a cutting position designated by an operator is one end position of the oscillation (for example, the lower end position), programming can be facilitated, but it is not possible to obtain a margin for air cutting because the one end position of oscillation has been designated. In actual machining, there are many cases where the oscillation amplitude attenuates with respect to that in an oscillation command. Therefore, there is the risk that air cutting will not be appropriately executed if it is not possible to ensure a margin that considers attenuation.

The present disclosure is made in light of the problems described above, and an object of the present disclosure is to provide a technique that, in a control device that is for a machine tool and controls both of thread cutting that has oscillation and thread cutting that does not have oscillation, enables a machining program to be easily set and also enables air cutting to be reliably executed.

### Means for Solving the Problems

The present disclosure is a control device for a machine tool that uses a cutting tool to perform thread cutting with respect to a workpiece, the control device being provided with: a cutting position acquisition unit configured to acquire a cutting position for the thread cutting; a margin acquisition unit configured to acquire a margin that is set such that the cutting tool oscillates beyond the cutting position in thread cutting that has oscillation; an oscillation amplitude information acquisition unit configured to acquire oscillation amplitude information that indicates an oscillation amplitude of the thread cutting that has oscillation; and a thread cutting command generation unit configured to, based on the cutting position, the margin, and the oscillation amplitude information, generate a thread cutting command for oscillation such that at least one end position in a direction of oscillation goes beyond the cutting position.

### Effects of the Invention

By virtue of the present disclosure, it is possible to provide a technique that, in a control device that is for a machine tool and controls both of thread cutting that has oscillation and thread cutting that does not have oscillation, enables a machining program to be easily set and also enables air cutting to be reliably executed.

### BRIEF DESCRIPTION OF THE DRAWINGS

FIG. 1 is a functional block diagram of a control device that is for a machine tool and is according to a first embodiment of the present invention;

FIG. 2 is a view illustrating an example of a machining program according to the first embodiment;

FIG. 3 is a graph illustrating a positional relationship between a workpiece and a cutting tool, in the first embodiment;

FIG. 4 is an enlarged view of the graph in FIG. 3, and illustrates an upper end position and a lower end position of oscillation in the first embodiment;

FIG. 5 is a graph illustrating a positional relationship between a workpiece and a cutting tool, for a plurality of cycles in the first embodiment;

FIG. 6 is a graph illustrating a route for a cutting tool in thread cutting that has oscillation and thread cutting that does not have oscillation, according to a conventional technique;

FIG. 7 is a graph illustrating a route for a cutting tool in thread cutting that has oscillation and thread cutting that does not have oscillation, according to the present embodiment;

FIG. 8 is a graph illustrating a positional relationship between a workpiece and a cutting tool, in a second embodiment;

FIG. 9 is an enlarged view of the graph in FIG. 8, and illustrates an upper end position and a lower end position of oscillation in the second embodiment;

FIG. 10 is a graph illustrating a positional relationship between a workpiece and a cutting tool, for a plurality of cycles in the second embodiment;

FIG. 11 is a functional block diagram illustrating a configuration of a thread cutting command generation unit according to a third embodiment;

FIG. 12 is a graph illustrating a positional relationship between a workpiece and a cutting tool, in a method of generating a thread cutting command according to the third embodiment;

FIG. 13 is a graph illustrating a positional relationship between a workpiece and a cutting tool, in a method of generating a thread cutting command according to a fourth embodiment;

FIG. 14 is a graph illustrating a positional relationship between a workpiece and a cutting tool, in a method of generating a thread cutting command according to a fifth embodiment;

FIG. 15 is a functional block diagram illustrating a configuration of a thread cutting command generation unit according to a sixth embodiment;

FIG. 16 is a graph illustrating a positional relationship between a workpiece and a cutting tool, in a method of generating a thread cutting command according to the sixth embodiment;

FIG. 17 is a functional block diagram illustrating a configuration of a thread cutting command generation unit according to a seventh embodiment;

FIG. 18 is a graph illustrating a positional relationship between a workpiece and a cutting tool, in a method of generating a thread cutting command according to the seventh embodiment;

FIG. 19 is a functional block diagram of a control device that is for a machine tool and is according to an eighth embodiment.

### PREFERRED MODE FOR CARRYING OUT THE INVENTION

Description is given in detail below regarding embodiments according to the present disclosure, with reference to the drawings. Note that, in the description of the second embodiment and thereafter, the same reference symbol is added to configurations common to the first embodiment, and description thereof is omitted, as appropriate.

### FIRST EMBODIMENT

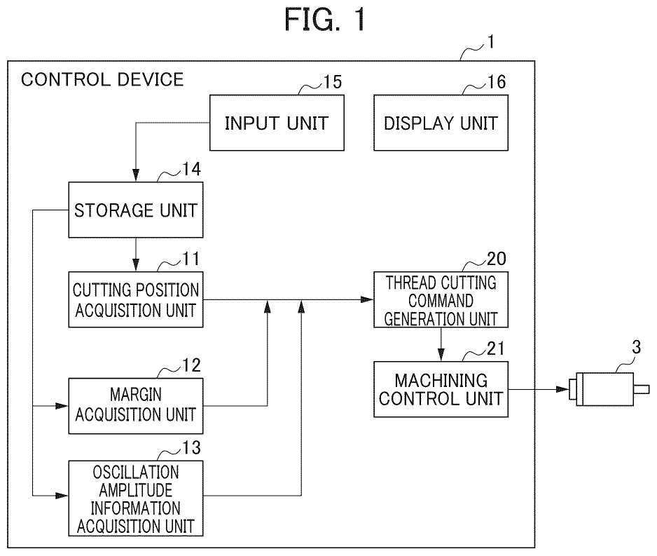

FIG. 1 is a functional block diagram of a control device 1 that is for a machine tool and is according to a first embodiment of the present invention. The control device 1, which is for a machine tool and is illustrated in FIG. 1, is for using a cutting tool that oscillates in a radial direction with respect to a workpiece to thereby execute thread cutting. Note that, in FIG. 1, only a motor 3 that drives one feed shaft is illustrated for convenience. In addition, the shape of a workpiece is not limited in cutting according to the present embodiment. In other words, application is possible even in a case where a plurality of feed shafts (a Z axis and an X axis) becomes necessary due to a workpiece having a tapered section or an arc-shaped section on a machined surface, and even in a case where a workpiece is columnar or cylindrical and one specific shaft (a Z axis) as the feed shaft is sufficient.

The machine tool control device 1 according to the present embodiment is configured by using a computer that is provided with, for example, a memory such as a ROM (read-only memory) and a RAM (random-access memory), a CPU (central processing unit), and a communication control unit, which are mutually connected via a bus. The functionality of and operations by each functional unit described below are achieved by the CPU and memory mounted to the above-described computer collaborating with a control program that is stored in the memory. In addition, the machine tool control device 1 may be configured by a CNC (Computer Numerical Controller), a PLC (Programmable Logic Controller), or the like, or may be connected to a higher-order computer that outputs, inter alia, a machining condition such as a rotation speed, in addition to a machining program.

As illustrated in FIG. 1, the machine tool control device 1 is provided with a cutting position acquisition unit 11, a margin acquisition unit 12, an oscillation amplitude information acquisition unit 13, a thread cutting command generation unit 20, a machining control unit 21, a storage unit 14, an input unit 15, and a display unit 16.

The cutting position acquisition unit 11 acquires a cutting position for a cutting tool with respect to a workpiece, in thread cutting. For example, the cutting position may be stored in the storage unit 14, or may be outputted from an external computer.

The margin acquisition unit 12 acquires a margin as information for setting an oscillation waveform such that there is oscillation beyond the cutting position acquired by the cutting position acquisition unit 11. For example, the margin is information for determining a width for oscillation that goes beyond the cutting position. For example, the margin may be stored in the storage unit 14, or may be outputted from an external computer.

The oscillation amplitude information acquisition unit 13 acquires oscillation amplitude information, which indicates an oscillation amplitude, from a later-described machining condition or the like. For example, the oscillation amplitude may be stored in the storage unit 14, or may be outputted from an external computer.

The thread cutting command generation unit 20 generates a thread cutting command for executing thread cutting. The thread cutting command is generated by the thread cutting command generation unit 20, based on the cutting position acquired by the cutting position acquisition unit 11, the margin acquired by the margin acquisition unit 12, and the oscillation amplitude acquired by the oscillation amplitude information acquisition unit 13. Note that details of a process for generating a thread cutting command are described below.

The machining control unit 21 performs operation control, which is based on the thread cutting command generated by the thread cutting command generation unit 20. In accordance with the operation control, the motor 3 and the like are driven, the workpiece and the cutting tool move, and thread cutting is executed.

The storage unit 14 stores various items of information for the purpose of machining by or control of the machine tool. In the present embodiment, the storage unit 14 stores a machining condition and an oscillation condition. The machining condition and the oscillation condition are, for example, inputted to a machining program by an operator, or are designated as parameters for the machine tool. Note that configuration may be such that the storage unit 14 is disposed externally, instead of inside the control device 1.

An oscillation condition stored in the storage unit 14 includes information pertaining to a number of oscillations in the radial direction of the workpiece, and information pertaining to an oscillation amplitude in the radial direction of the workpiece. The information pertaining to the number of oscillations in the radial direction of the workpiece may be an oscillation frequency multiplying factor I (times) that indicates the oscillation frequency for each rotation by a main shaft. In addition, the information pertaining to the oscillation amplitude in the radial direction for the workpiece, which is relative between the cutting tool and the workpiece, may be an oscillation amplitude multiplying factor K (times) that indicates the magnitude of the oscillation amplitude with respect to the amount of cutting in the radial direction for the workpiece in thread cutting.

A machining condition stored in the storage unit 14 includes information that pertains to the shape of a thread, a condition for cutting the workpiece, etc. For example, the information that pertains to the shape of the thread may be the thread lead (mm), the thread diameter (mm), the angle (°) of a thread crest, or the like. The condition for cutting a workpiece may be a main shaft rotation number S (1/min), a finishing margin (mm), a number of times for finishing machining (times), a cutting position (mm), or the like. The cutting position is a reference position such as one end position in the direction of oscillation (for example, the lower end position) or the other end position (upper end position), and is not limited in particular. Furthermore, a cutting position may be information that enables identification of the cutting position, such as a cutting area. In this manner, the amount of cutting may be a length or an area, or may be information for identifying a position.

The input unit 15 is for, for example, inputting information pertaining to machining, in response to an input operation by an operator with respect to an input means (not shown) such as a keyboard or a touch panel. Information that pertains to machining and is inputted using the input unit 15 is stored in the storage unit 14 or the like, or is inputted to units in the control device 1.

The display unit 16 displays various items of information that pertain to the machine tool, the control device 1, and machining. The display unit 16 is, for example, configured by a display.

Description regarding an overall configuration of the control device 1 is given above. Next, description is given regarding a flow of a process for generating an oscillation command by the control device 1 according to the present embodiment.

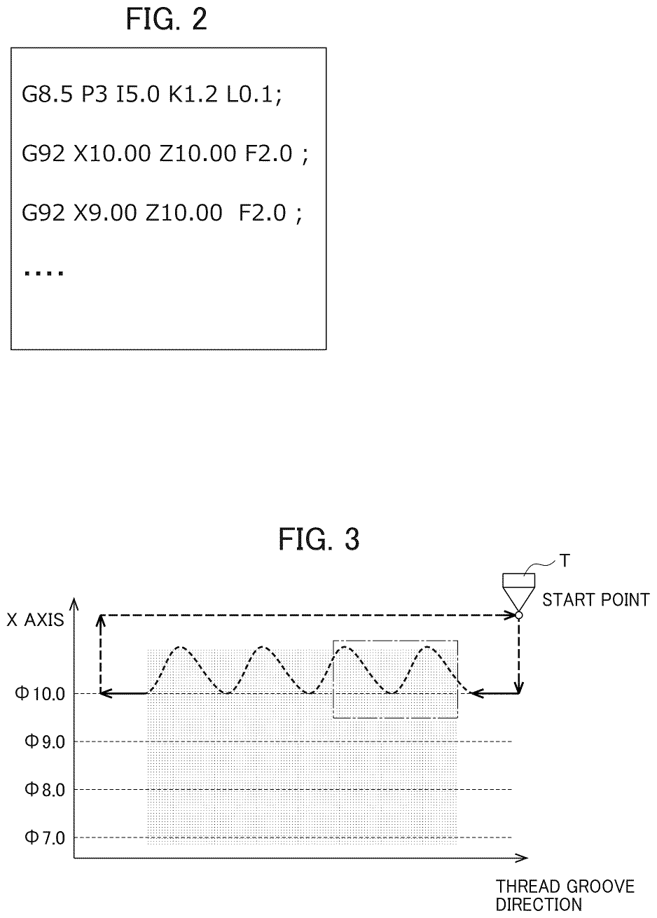

FIG. 2 is a view that illustrates an example of a machining program according to the first embodiment. “I5.0 K1.2” that follows the code “G8.5” in this machining program indicates an oscillation condition such as an oscillation frequency, an oscillation amplitude, or the like. “G92” is a code for generating an operation for one cycle of thread cutting, in a command for one block. The “X10.00 Z10.00 F2.0” after the “G92” indicates machining conditions for thread cutting, indicating a position or a feed amount.

Description is given regarding a process for generating an oscillation command. In the process for generating an oscillation command, firstly, the oscillation amplitude information acquisition unit 13 acquires oscillation amplitude information that indicates an amplitude of 1.2 [mm] from the “K1.2” in the machining program.

Next, the cutting position acquisition unit 11 acquires a machining condition for thread cutting (thread pitch, lead, etc.) from the “G92 X10.00 Z10.00 F2.0” in the machining program. The cutting position acquisition unit 11 analyzes that the cutting position is X=10.0 [mm] in thread cutting from the wording “X10.00”.

The margin acquisition unit 12 acquires a margin from “G8.5 P3 I5.0 K1.2 L0.1” in the machining program. Note that, in this example, acquisition is from the machining program, but there is no limitation thereto. For example, the margin may be acquired from a parameter that is set to the machine tool. Further, the margin does not need to be directly designated. A multiplying factor with respect to an amount of thread cutting each time may be acquired as information that indicates the margin.

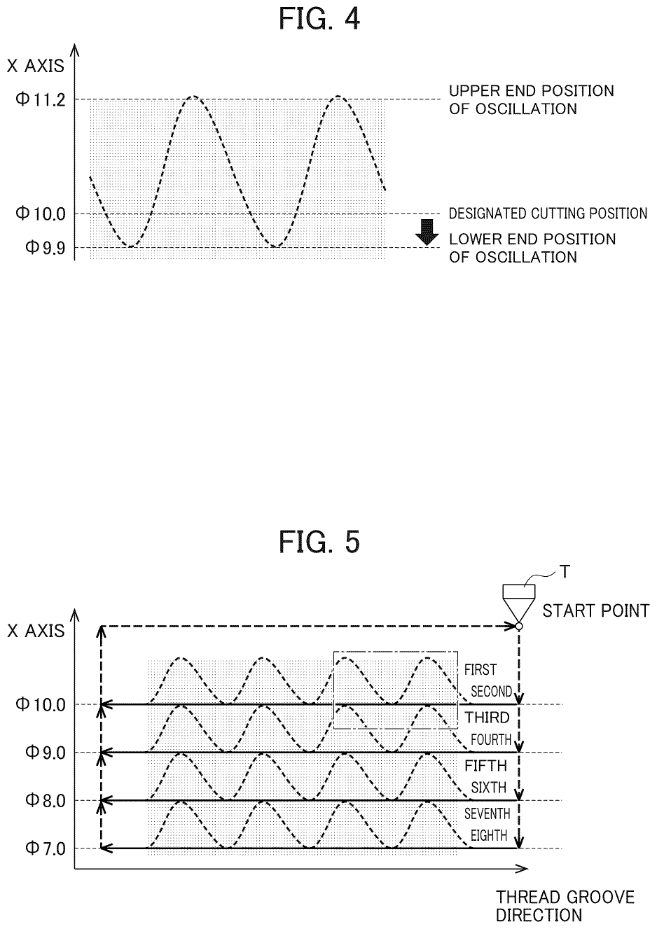

Next, with reference to FIG. 3 and FIG. 4, description is given regarding the thread cutting command generation unit 20. FIG. 3 is a graph that illustrates a positional relationship between a workpiece and a cutting tool T, in the first embodiment. FIG. 4 is an enlarged view of the graph in FIG. 3, and illustrates an upper end position and a lower end position of oscillation in the first embodiment.

The thread cutting command generation unit 20 determines an upper end position that is one end position of an oscillation operation, and a lower end position that is the other end position for the oscillation operation.

The thread cutting command generation unit 20 firstly sets the lower end position for the oscillation operation, based on the cutting position acquired by the cutting position acquisition unit 11 and the margin acquired by the margin acquisition unit 12. As illustrated in FIG. 3 and FIG. 4, in this example, 9.9 resulting from subtracting a margin of 0.1 [mm] from the cutting position X=10.0 [mm] is determined as the lower end position.

The thread cutting command generation unit 20 determines the upper end position based on the oscillation amplitude acquired by the oscillation amplitude information acquisition unit 13. In this example, 11.2 [mm] resulting from adding the cutting position of 10.0 [mm] to the oscillation amplitude of 1.2 [mm] is determined as the upper end position.

The thread cutting command generation unit 20 generates an oscillation command based on the generated upper end position and lower end position for oscillation, and oscillation conditions acquired from the machining program. For example, the oscillation may be a sine wave, or may be a triangular wave or the like if the oscillation is a periodic signal.

Next, with reference to FIG. 5, description is given regarding an example of generating an oscillation command for a plurality of cycles. FIG. 5 is a graph that illustrates a positional relationship between a workpiece and the cutting tool T, for a plurality of cycles in the first embodiment. One cycle is, for example, a series of operations from a start point that is for the cutting tool T and is illustrated in FIG. 5, until the start point is returned to again after the cutting tool T comes into contact with workpiece and machining is performed. As illustrated in FIG. 5, the thread cutting command generation unit 20 generates a thread cutting command for performing a plurality of cycles of thread cutting.

In the example in FIG. 5, the cutting is divided into steps in which cutting is performed using oscillation in the X-axis direction, and steps in which cutting without oscillation is performed after said cutting. Thread cutting that has oscillation is executed in the first, third, fifth, and seventh cycles. The depth of the cutting deepens as each of the first, third, fifth, and seventh cycles are advanced to. For cutting that accompanies oscillation, an oscillation condition such as an amplitude is setting such that all paths for cutting are positioned radially outside the surface of the workpiece. Thread cutting that does not have oscillation is performed in the second, fourth, sixth, and eighth cycles.

Air cutting for cutting chips is realized by a route for thread cutting that has oscillation intersecting with a route for thread cutting that does not have oscillation. For example, an oscillation command is generated such that the depth at the lower end side of the first thread cutting that has oscillation intersects with the depth of the second thread cutting. As a result, chips can be shredded even in cutting that accompanies various oscillation. Even in final cutting of a thread groove that does not include oscillation, it is possible to shred chips and it is also possible to realize a machined surface that has high accuracy.

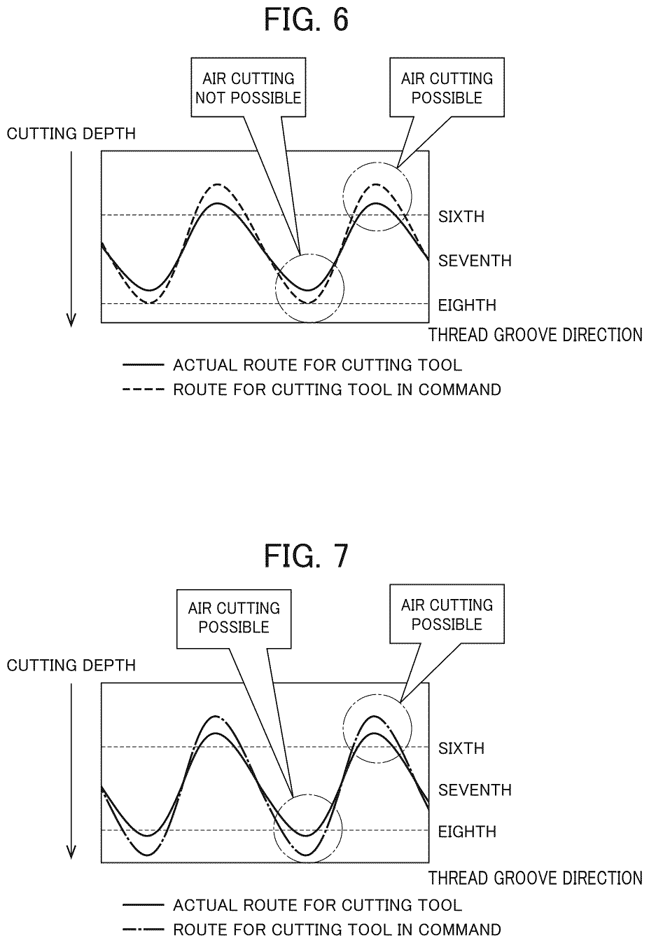

With reference to FIG. 6, description is given regarding a conventional technique. FIG. 6 is a graph that illustrates a route for the cutting tool T in thread cutting that has oscillation and thread cutting that does not have oscillation, according to the conventional technique. As illustrated in FIG. 6, in thread cutting that has oscillation according to the conventional technique, the amplitude of a waveform that indicates the route for an actual cutting tool T attenuates, and the amplitude of the waveform indicating the route for the cutting tool T in the command decreases. In the example in FIG. 6, a state has been entered in which air cutting is possible by the route for the sixth instance of thread cutting, which has oscillation, intersecting with the route for the seventh instance of thread cutting, which does not have oscillation. However, the route for the seventh thread cutting, which has oscillation, and the route for the eighth thread cutting, which does not have oscillation, intersect in the command but due to amplitude attenuation do not actually intersect, and thus a state in which air cutting is not possible is entered.

In order to reliably execute air cutting, consideration has been given to generating a command with a large oscillation amplitude to thereby ensure a margin for air cutting. However, the position of the lower end side of oscillation is directly designated in a program, and thus it has not been possible to achieve a margin for air cutting on the lower end side of oscillation.

FIG. 7 is a graph that illustrates a route for the cutting tool T in thread cutting that has oscillation and thread cutting that does not have oscillation, according to the present embodiment. Regarding this point, as illustrated in FIG. 7, by virtue of the configuration of the present embodiment, even in a case where an actual oscillation amplitude has attenuated past the oscillation amplitude in a command, the oscillation command is generated in advance in consideration of attenuation, and thus the routes for thread cutting that has oscillation and thread cutting that does not have oscillation intersect. In this example, in contrast to not intersecting in the conventional technique, the route for the seventh instance of thread cutting, which has oscillation, intersects with the route for the eighth instance of thread cutting, which does not have oscillation, and air cutting is executed.

By virtue of the control device 1 that is for a machine tool, is according to the first embodiment, and uses the cutting tool T to perform thread cutting on a workpiece as described above, the following effects are achieved.

The control device 1 that is for a machine tool and is according to the present embodiment is provided with the cutting position acquisition unit 11 that acquires a cutting position for thread cutting, the margin acquisition unit 12 that acquires a margin that is set such that the cutting tool T oscillates beyond the cutting position in thread cutting that has oscillation, the oscillation amplitude information acquisition unit 13 that acquires oscillation amplitude information that indicates an oscillation amplitude of the thread cutting that has oscillation, and the thread cutting command generation unit 20 that, based on the cutting position, the margin, and the oscillation amplitude information, generates a thread cutting command for oscillation such that at least one end position in the direction of oscillation goes beyond the cutting position. As a result, the oscillation waveform is set to one that considers the margin while the ease of programming a machining program is maintained. Therefore, it is possible to realize the control device 1, which is for a machine tool and by which air cutting is reliably executed.

The thread cutting command generation unit 20 determines one end position in the direction of oscillation (the lower end position) based on the cutting position and the margin, determines the other end position in the direction of oscillation (the upper end position) based on the oscillation amplitude information, and generates a thread cutting command that is based on the one end position and the other end position. As a result, it is possible to perform calculations for determining the one end position and the other end position for amplitude oscillation without performing complex processing. Therefore, it is possible to effectively reduce a calculation cost for setting an oscillation waveform to a position at which air cutting can be reliably performed.

Description is given above regarding the control device 1 that is for a machine tool and is according to the first embodiment, but there is no limitation to the configuration of this embodiment. Description is given below regarding embodiments for cases that differ to that for the embodiment described above.

### SECOND EMBODIMENT

Next, description is given regarding a control device 1 according to a second embodiment. A control device 1 according to the second embodiment has a similar configuration to that of the first embodiment, apart from having a different process for generating an oscillation command using the thread cutting command generation unit 20. In the first embodiment, the lower end position is determined first and the upper end position is determined based on the lower end position and the oscillation amplitude, but the upper end position is determined first in the second embodiment.

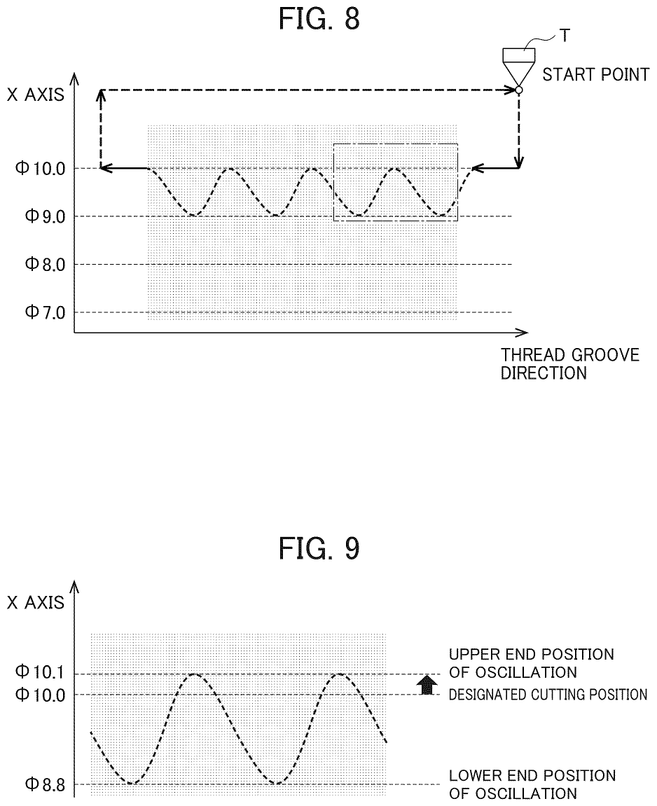

With reference to FIG. 8 and FIG. 9, description is given regarding the process for generating an oscillation command using the thread cutting command generation unit 20 according to the second embodiment. FIG. 8 is a graph that illustrates a positional relationship between a workpiece and a cutting tool T, in the second embodiment. FIG. 9 is an enlarged view of the graph in FIG. 8, and illustrates an upper end position and a lower end position of oscillation in the second embodiment.

The thread cutting command generation unit 20 firstly sets the upper end position for the oscillation operation, based on the cutting position acquired by the cutting position acquisition unit 11 and the margin acquired by the margin acquisition unit 12. As illustrated in FIG. 8 and FIG. 9, in this example, 10.1 resulting from adding a margin of 0.1 [mm] to the cutting position X=10.0 [mm] is determined as the upper end position.

The thread cutting command generation unit 20 determines the lower end position based on the oscillation amplitude acquired by the oscillation amplitude information acquisition unit 13. In this example, 8.8 [mm] resulting from subtracting the oscillation amplitude of 1.2 [mm] from the cutting position of 10.0 [mm] is determined as the lower end position.

In this manner, the thread cutting command generation unit 20 generates a command for executing thread cutting that has oscillation such that the upper end position is X=10.1 [mm] and the lower end position is X=8.8 [mm].

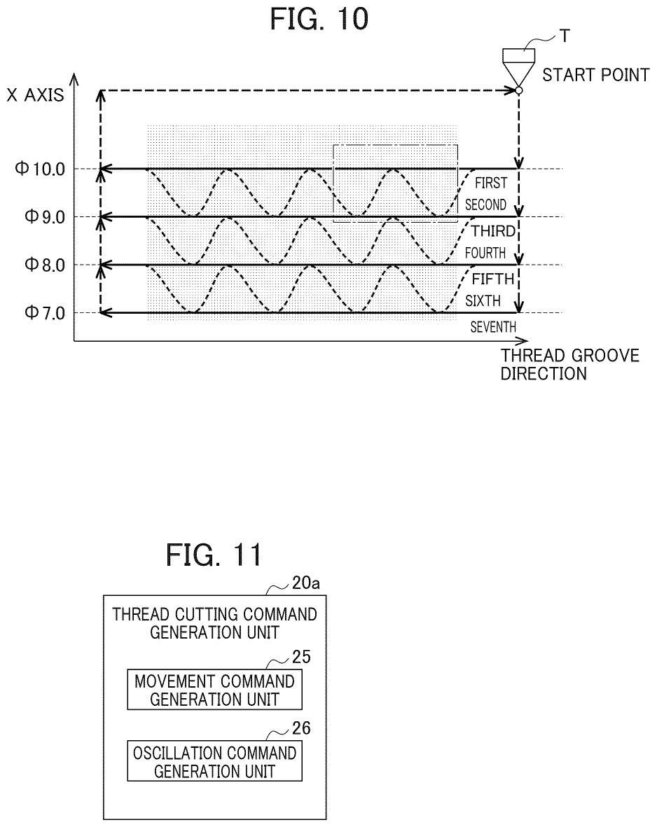

Next, with reference to FIG. 10, description is given regarding an example of generating an oscillation command for a plurality of cycles. FIG. 10 is a graph that illustrates a positional relationship between a workpiece and the cutting tool T, for a plurality of cycles in the second embodiment. The thread cutting command generation unit 20 generates an oscillation command in which the cutting is divided into steps in which cutting is performed using oscillation in the X-axis direction, and steps in which cutting without oscillation is performed after said cutting. In the example in FIG. 10, thread cutting that does not have oscillation is executed in the first, third, fifth, and seventh cycles. Thread cutting that has oscillation is performed in the second, fourth, sixth, and eighth cycles. Air cutting for cutting chips is realized by a route for thread cutting that has oscillation intersecting with a route for thread cutting that does not have oscillation.

### THIRD EMBODIMENT

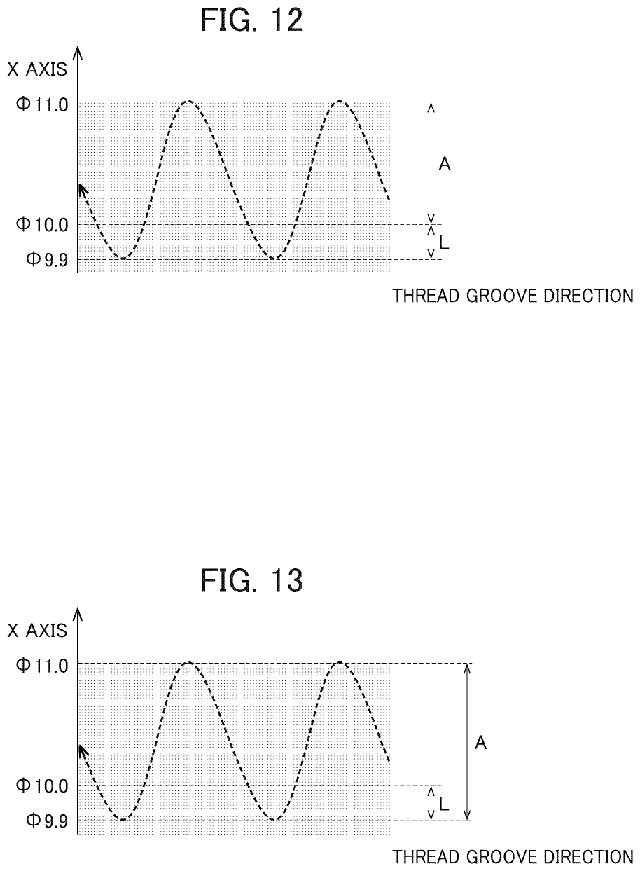

Next, description is given regarding a method of generating a thread cutting command that differs to that in the first embodiment. FIG. 11 is a functional block diagram that illustrates a configuration of a thread cutting command generation unit 20a according to a third embodiment. FIG. 12 is a graph that illustrates a positional relationship between a workpiece and a cutting tool T, in a method of generating a thread cutting command according to the third embodiment. Note that, in the third embodiment, configurations other than that of the thread cutting command generation unit 20a are similar to those in the embodiments described above.

As illustrated in FIG. 11, the thread cutting command generation unit 20a has a movement command generation unit 25 for generating a movement command, and an oscillation command generation unit 26 for generating an oscillation command.

The movement command generation unit 25 generates a movement command for controlling the position of the cutting tool T. The movement command is generated such that the cutting tool T moves to a cutting position in thread cutting. The oscillation command generation unit 26 generates an oscillation command for causing the cutting tool T to oscillate with respect to the workpiece. The oscillation command is generated in consideration of a margin.

In the example in FIG. 12, the movement command generation unit 25 generates a movement command F1 that is based on a cutting position of 10 mm. The oscillation command generation unit 26 uses a formula in Math 1 indicated below to calculate an oscillation command F2. In the formula in Math 1, A represents amplitude [mm], L represents margin [mm], and e represents oscillation phase [deg]. In the example in FIG. 12, it is assumed that the oscillation amplitude A is set to 1.0 mm, and the margin L is set to 0.1 mm.

$$F 2 = ( A + L ) \times ( 1 - cos θ ) - L \qquad [ Math 1 ]$$

The thread cutting command generation unit 20a generates a thread cutting command for performing thread cutting that has oscillation by superimposing the oscillation command F2 calculated by the oscillation command generation unit 26 using the formula in the above Math 1 with the movement command F1 generated by the movement command generation unit 25. As indicated in the formula in Math 1 or in FIG. 12, “A+L” becomes the oscillation amplitude indicated by the oscillation command, and “L” from this becomes an offset amount. A machining operation is executed based on a thread cutting command resulting from superimposing a movement command and an oscillation command in this manner.

### FOURTH EMBODIMENT

Description is given regarding a fourth embodiment for generating a thread cutting command by superimposing a movement command and an oscillation command by a method different to that in the third embodiment. FIG. 13 is a graph that illustrates a positional relationship between a workpiece and a cutting tool T, in a method of generating a thread cutting command according to the fourth embodiment.

In the example illustrated in FIG. 13, F2 can be expressed by the formula in the following Math 2. In the formula in Math 2, A represents amplitude [mm], L represents margin [mm], and 0 represents oscillation phase [deg]. In the example in FIG. 13, it is assumed that the oscillation amplitude A is set to 1.1 mm, and the margin L is set to 0.1 mm.

$$F 2 = ( A ) \times ( 1 - cos θ ) - L \qquad [ Math 2 ]$$

The thread cutting command generation unit 20a generates a thread cutting command for performing thread cutting that has oscillation by superimposing the oscillation command F2 calculated by the oscillation command generation unit 26 using the formula in Math 2 described above with the movement command F1 generated by the movement command generation unit 25. As indicated in the formula in Math 2 or in FIG. 13, “A” becomes the oscillation amplitude unchanged. A machining operation is executed based on a thread cutting command resulting from superimposing a movement command and an oscillation command in this manner.

By virtue of the control device 1 that is for a machine tool, is according to the third embodiment or the fourth embodiment, and uses the cutting tool T to perform thread cutting on a workpiece as described above, the following effects are achieved.

In the third embodiment or the fourth embodiment, the thread cutting command generation unit 20a has the movement command generation unit 25 that generates a movement command for causing the cutting tool T to move in thread cutting and the oscillation command generation unit 26 that generates, based on oscillation amplitude information, an oscillation command for determining an operation having an oscillation amplitude in thread cutting, and generates a thread cutting command by superimposing the movement command and the oscillation command that is offset by the margin L. As a result, using a process for superimposing the movement command and the oscillation command, it is possible to easily set an oscillation waveform to a position where air cutting can be reliably performed.

### FIFTH EMBODIMENT

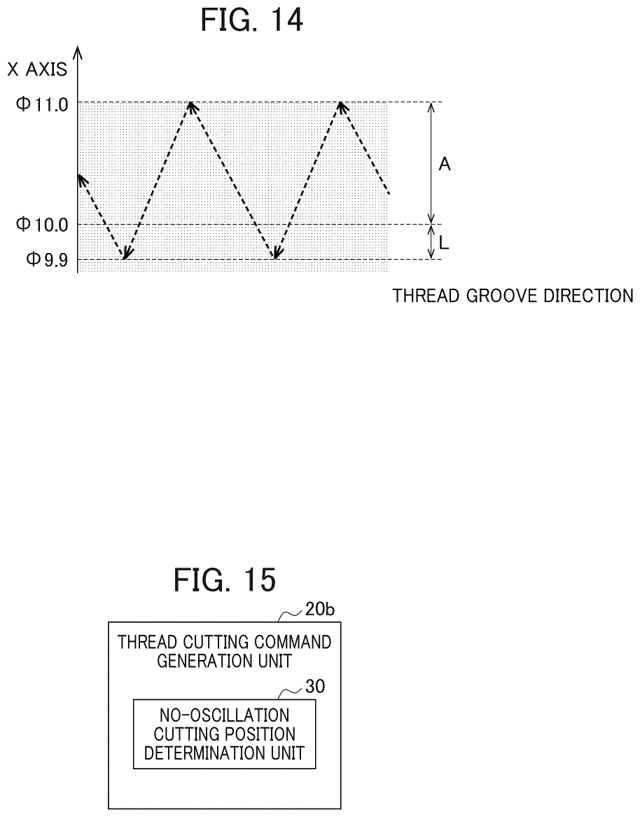

Furthermore, description is given regarding a fifth embodiment for directly generating a thread cutting command without superimposing a movement command and an oscillation command. FIG. 14 is a graph that illustrates a positional relationship between a workpiece and a cutting tool T, in a method of generating a thread cutting command according to the fifth embodiment. As illustrated in FIG. 14, a thread cutting command is directly generated instead of superimposing a movement command and an oscillation command. In this example, it is assumed that the oscillation amplitude is set to 1.0 mm and the margin L is set to 0.1 mm, with “A+L” becoming the oscillation amplitude.

### SIXTH EMBODIMENT

Next, description is given regarding a sixth embodiment for generating a thread cutting command by a different method to those in embodiments described above. In the sixth embodiment, a thread cutting command generation unit 20b generates a thread cutting command such that a cutting position for thread cutting that has oscillation differs to a cutting position for thread cutting that does not have oscillation.

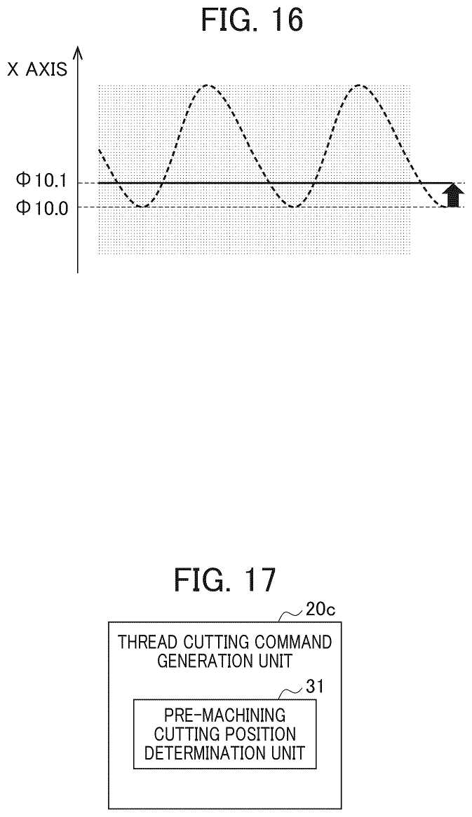

FIG. 15 is a functional block diagram that illustrates a configuration of the thread cutting command generation unit 20b according to the sixth embodiment. FIG. 16 is a graph that illustrates a positional relationship between a workpiece and a cutting tool T, in a method of generating a thread cutting command according to the sixth embodiment.

As illustrated in FIG. 15, the thread cutting command generation unit 20b is provided with a no-oscillation cutting position determination unit 30. The no-oscillation cutting position determination unit 30 determines a no-oscillation cutting position based on a cutting position acquired by the cutting position acquisition unit 11, and a margin acquired by the margin acquisition unit 12.

In the present embodiment, the margin acquisition unit 12 functions as a shift amount acquisition unit that acquires, as a margin for changing a position in an oscillation waveform, a shift amount for changing a cutting position. In the example indicated in FIG. 16, a margin of 0.1 [mm] is added to a cutting position X=10.00 [mm], and 10.10 [mm] is determined as a cutting position for a time of thread cutting that does not have oscillation.

By virtue of the control device 1 that is for a machine tool, is according to the sixth embodiment, and uses the cutting tool T to perform thread cutting on a workpiece as described above, the following effects are achieved.

The thread cutting command generation unit 20b according to the sixth embodiment has the no-oscillation cutting position determination unit 30 that sets a no-oscillation cutting position for a time of thread cutting that does not have oscillation based on a cutting position and a margin. The thread cutting command generation unit 20b generates a thread cutting command for executing thread cutting based on a cutting position acquired based on the cutting position acquisition unit 11 in thread cutting that has oscillation, and for executing thread cutting based on the no-oscillation cutting position set by the no-oscillation cutting position determination unit 30 in thread cutting that does not have oscillation. As a result, it is possible to realize a configuration that enables a margin for air cutting to be ensured by a simple process of adjusting the cutting position in thread cutting that does not have oscillation.

### SEVENTH EMBODIMENT

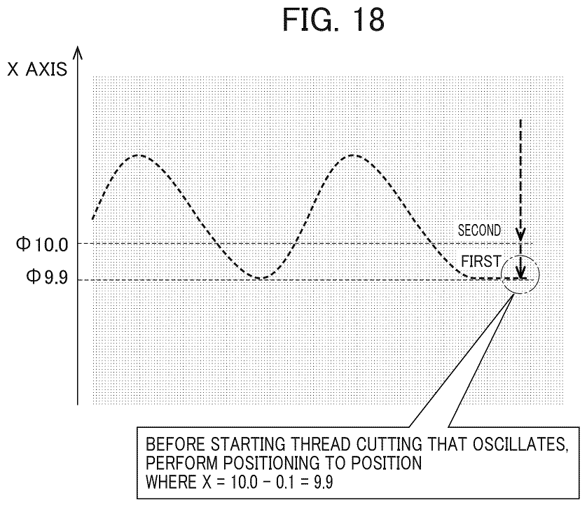

Next, description is given regarding a seventh embodiment for generating a thread cutting command by a different method to those in embodiments described above. FIG. 17 is a functional block diagram that illustrates a configuration of the thread cutting command generation unit 20c according to the seventh embodiment. FIG. 18 is a graph that illustrates a positional relationship between a workpiece and a cutting tool T, in a method of generating a thread cutting command according to the seventh embodiment.

As illustrated in FIG. 17, the thread cutting command generation unit 20c is provided with a pre-machining cutting position determination unit 31. The pre-machining cutting position determination unit 31 determines a no-oscillation cutting position based on a cutting position acquired by the cutting position acquisition unit 11, and a margin acquired by the margin acquisition unit 12.

Even in the present embodiment, the margin acquisition unit 12 functions as a shift amount acquisition unit that acquires, as a margin for changing a position in an oscillation waveform, a shift amount for changing a cutting position. In the example illustrated in FIG. 18, 9.9 [mm] resulting from subtracting a margin of 0.1 [mm] from X=10.00 [mm] is determined as a cutting position for before the start of machining.

The pre-machining cutting position determination unit 31 executes a determination of the above-described cutting position at a timing that is before thread cutting that has oscillation is executed. The thread cutting command generation unit 20 generates a thread cutting command based on the cutting position, and outputs the thread cutting command to the machining control unit 21. The machining control unit 21 executes a positioning process based on the cutting position determined by the pre-machining cutting position determination unit 31, and subsequently executes oscillation cutting.

By virtue of the control device 1 that is for a machine tool, is according to the seventh embodiment, and uses the cutting tool T to perform thread cutting on a workpiece as described above, the following effects are achieved.

The thread cutting command generation unit 20c according to the seventh embodiment has the pre-machining cutting position determination unit 31 that, based on a cutting position and a margin, sets an oscillation cutting position for a time of thread cutting that has oscillation. The thread cutting command generation unit 20c executes thread cutting that has oscillation after performing positioning to the cutting position determined by the pre-machining cutting position determination unit 31 prior to the start of machining.

### EIGHTH EMBODIMENT

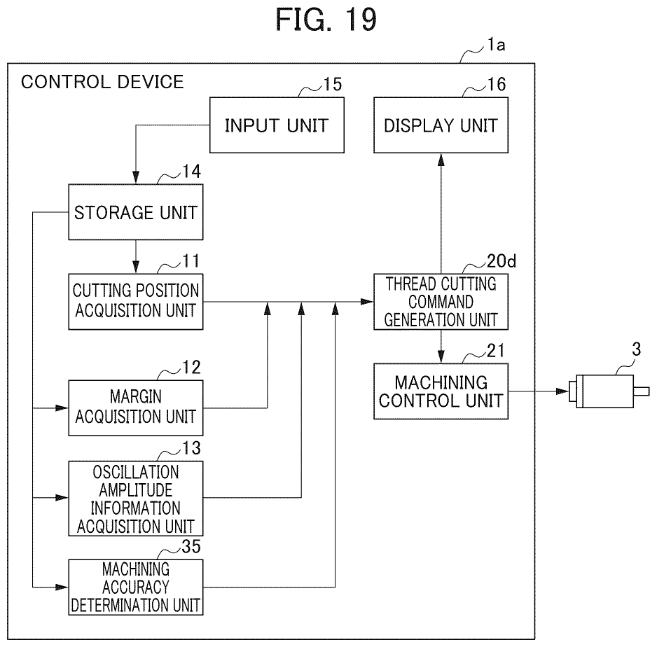

Next, with reference to FIG. 19, description is given regarding a control device 1a according to an eighth embodiment. FIG. 19 is a functional block diagram of a control device that is for a machine tool and is according to the eighth embodiment. The control device 1a according to the eighth embodiment differs in configuration from the control device 1 according to embodiments described above in being further provided with a machining accuracy determination unit 35, and in processing by a thread cutting command generation unit 20d.

The machining accuracy determination unit 35 determines a level of machining accuracy from a statement in a machining program. The level of machining accuracy determined by the machining accuracy determination unit 35 is determined based on, for example, a type of a code written in the machining program, a dedicated determination code that is added near a code, or the like.

Description is given regarding a case of making a determination by a code type, in the determination of the level of machining accuracy. For example, the code “G76” is for generating a movement block for thread cutting across a plurality of times, in a command for one block in a machining program. In a case where the code “G76” is written in a machining program, it is possible to achieve a configuration for determining the degree of importance of machining accuracy in thread cutting for each cycle, based on a target value that is written in a block that is after “G76”. For example, setting may be performed such that the highest degree of importance is employed for final finishing, and the degree of importance of machining accuracy increases as the final finishing is approached over a plurality of cycles.

Description is given regarding a case of making a determination by dedicated determination code, in the determination of the level of machining accuracy. For example, in a case where a dedicated determination code (for example, characters such as “L0”) is added to a “G32” or “G92” block in a machining program, the level of machining accuracy is determined based on the determination code. In this case, the determination code itself includes information that indicates the degree of importance of machining accuracy.

The thread cutting command generation unit 20d executes a process for correcting the margin in accordance with the level of machining accuracy determined by the machining accuracy determination unit 35. For example, in the case of final finishing the degree of importance of machining accuracy is highest. Therefore, the thread cutting command generation unit 20d sets the margin to 0, and reduces the margin in a stage before the final finishing. It may be that the amount that the margin is reduced by decreases, going from the final finishing towards earlier stages. In this case, the margin becomes relatively larger going from the final finishing towards earlier stages.

By virtue of the control device 1a that is for a machine tool, is according to the eighth embodiment, and uses the cutting tool T to perform thread cutting on a workpiece as described above, the following effects are achieved.

The control device 1a that is for a machine tool and is according to the present embodiment is further provided with the machining accuracy determination unit 35 that determines a level of machining accuracy. The thread cutting command generation unit 20d sets a value for a margin that correspond to the level of machining accuracy determined by the machining accuracy determination unit 35. As a result, the machining accuracy is reflected to the margin and it is possible to establish both high machining accuracy and execution of reliable air cutting at a high level.

Note that, in the embodiments described above, a command in which thread cutting that has oscillation and thread cutting that does not have oscillation are alternatingly repeated is automatically generated, but there is no limitation thereto.

For example, a configuration may be employed in which thread cutting that has oscillation is executed a plurality of times, and subsequently thread cutting that does not have oscillation is performed at least once. In this case, in order to perform an air cutting process, it is desirable for machining control to be performed after adjusting an oscillation condition such that peaks and troughs in consecutive thread cutting that has oscillation overlap. For example, it is possible to overlap peaks and troughs in consecutive thread cutting that has oscillation by the thread cutting command generation unit 20, 20a to 20d performing a process for shifting the phase of an oscillation condition by 180 degrees.

The present disclosure was described in detail, but the present disclosure is not limited to each embodiment described above. These embodiments can be subjected to various additions, replacements, changes, partial deletions, or the like within a scope that does not deviate from the substance of the present disclosure or within a scope that does not deviate from the purport of the present disclosure derived from the content set forth in the claims or equivalents thereto. In addition, these embodiments can be worked in combination. For example, the order of operations or the order of processes in the embodiments described above is indicated as an example, and there is no limitation thereto. In addition, it is similar for cases in which numbers or formulas are used for the description of the embodiments described above.

In relation to embodiments and variations described above, the following additional remarks are also disclosed.

### (Additional Remark 1)

A control device (1, 1a) for a machine tool that uses a cutting tool (T) to perform thread cutting with respect to a workpiece, the control device being provided with:
a cutting position acquisition unit (11) configured to acquire
a cutting position for the thread cutting;
a margin acquisition unit (12) configured to acquire a margin that is set such that the cutting tool (T) oscillates beyond the cutting position in thread cutting that has oscillation; an oscillation amplitude information acquisition unit (13) configured to acquire oscillation amplitude information that indicates an oscillation amplitude of the thread cutting that has oscillation; and
a thread cutting command generation unit (20, 20a to 20d) configured to, based on the cutting position, the margin, and the oscillation amplitude information, generate a thread cutting command for oscillation such that at least one end position in a direction of oscillation goes beyond the cutting position.

### (Additional Remark 2)

In the control device (1) for a machine tool, the thread cutting command generation unit (20) determines the one end position in the direction of oscillation based on the cutting position and the margin, determines an other end position in the direction of oscillation based on the oscillation amplitude information, and generates the thread cutting command based on the one end position and the other end position.

### (Additional Remark 3)

In the control device (1) for a machine tool, the thread cutting command generation unit (20a) has a movement command generation unit (25) configured to generate a movement command for causing the cutting tool (T) to move in thread cutting, and
an oscillation command generation unit (26) configured to, based on the oscillation amplitude information, generate an oscillation command for determining an operation that has an oscillation amplitude in thread cutting, and
the thread cutting command generation unit (20a) generates the thread cutting command by superimposing the movement command and the oscillation command that is offset based on the margin.

### (Additional Remark 4)

In the control device (1) for a machine tool, the thread cutting command generation unit (20c) has the pre-machining cutting position determination unit (31) configured to, based on the cutting position and the margin, set an oscillation cutting position for a time of the thread cutting that has oscillation, and generates the thread cutting command that is for executing the thread cutting that has oscillation after positioning to the cutting position determined by the pre-machining cutting position determination unit (31) is performed prior to a start of machining.

### (Additional Remark 5)

A control device (1, 1a) for a machine tool that uses a cutting tool (T) to perform thread cutting with respect to a workpiece, the control device being provided with:
a cutting position acquisition unit (11) configured to acquire
a cutting position for the thread cutting;
a margin acquisition unit (12) configured to acquire a margin that is set such that the cutting tool (T) goes beyond the cutting position in thread cutting that does not have oscillation;
an oscillation amplitude information acquisition unit (13) configured to acquire oscillation amplitude information that indicates an oscillation amplitude of the thread cutting that has oscillation; and
a thread cutting command generation unit (20, 20a to 20d) configured to generate a thread cutting command based on the cutting position, the margin, and the oscillation amplitude information,
the thread cutting command generation unit (20b) having a no-oscillation cutting position determination unit (30) configured to, based on the cutting position and the margin, set a no-oscillation cutting position that is for a time of the thread cutting that does not have oscillation, and generating the thread cutting command that is for executing thread cutting based on the cutting position acquired based on the cutting position acquisition unit (11) in the thread cutting that has oscillation, and for executing the thread cutting based on the no-oscillation cutting position set by the no-oscillation cutting position determination unit (30) in the thread cutting that does not have oscillation.

### (Additional Remark 6)

In the control device (1, 1a) for a machine tool, a machining accuracy determination unit (35) configured to determine a level of machining accuracy is also provided, and the thread cutting command generation unit (20d) sets a value for the margin that correspond to the level of machining accuracy determined by the machining accuracy determination unit (35).

### EXPLANATION OF REFERENCE NUMERALS

1, 1a Control device for machine tool
11 Cutting position acquisition unit
12 Margin acquisition unit
13 Oscillation amplitude information acquisition unit
20, 20a through 20d Thread cutting command generation unit
25 Movement command generation unit
26 Oscillation command generation unit
30 No-oscillation cutting position determination unit
31 Pre-machining cutting position determination unit
35 Machining accuracy determination unit
T Cutting tool

1. A control device for a machine tool that uses a cutting tool to perform thread cutting with respect to a workpiece, the control device comprising:
a cutting position acquisition unit configured to acquire a cutting position for the thread cutting;
a margin acquisition unit configured to acquire a margin that is set such that the cutting tool oscillates beyond the cutting position in thread cutting that has oscillation;
an oscillation amplitude information acquisition unit configured to acquire oscillation amplitude information that indicates an oscillation amplitude of the thread cutting that has oscillation; and
a thread cutting command generation unit configured to, based on the cutting position, the margin, and the oscillation amplitude information, generate a thread cutting command for oscillation such that at least one end position in a direction of oscillation goes beyond the cutting position.

2. The control device according to claim 1, wherein
the thread cutting command generation unit
determines the one end position in the direction of oscillation based on the cutting position and the margin, determines an other end position in the direction of oscillation based on the oscillation amplitude information, and generates the thread cutting command based on the one end position and the other end position.

3. The control device according to claim 1, wherein
the thread cutting command generation unit has
a movement command generation unit configured to generate a movement command for causing the cutting tool to move in thread cutting, and
an oscillation command generation unit configured to, based on the oscillation amplitude information, generate an oscillation command for determining an operation that has an oscillation amplitude in thread cutting, and
generates the thread cutting command by superimposing the movement command and the oscillation command that is offset based on the margin.

4. The control device according to claim 1, wherein
the thread cutting command generation unit has
a pre-machining cutting position determination unit configured to, based on the cutting position and the margin, set an oscillation cutting position for a time of the thread cutting that has oscillation, and
generates the thread cutting command that is for executing the thread cutting that has oscillation after positioning to the cutting position determined by the pre-machining cutting position determination unit is performed prior to a start of machining.

5. A control device for a machine tool that uses a cutting tool to perform thread cutting with respect to a workpiece, the control device comprising:
a cutting position acquisition unit configured to acquire a cutting position for the thread cutting;
a margin acquisition unit configured to acquire a margin that is set such that the cutting tool goes beyond the cutting position in thread cutting that does not have oscillation;
an oscillation amplitude information acquisition unit configured to acquire oscillation amplitude information that indicates an oscillation amplitude of the thread cutting that has oscillation; and
a thread cutting command generation unit configured to generate a thread cutting command based on the cutting position, the margin, and the oscillation amplitude information, wherein
the thread cutting command generation unit has
a no-oscillation cutting position determination unit configured to, based on the cutting position and the margin, set a no-oscillation cutting position that is for a time of the thread cutting that does not have oscillation, and
generates the thread cutting command that is for executing thread cutting based on the cutting position acquired based on the cutting position acquisition unit in the thread cutting that has oscillation, and for executing the thread cutting based on the no-oscillation cutting position set by the no-oscillation cutting position determination unit in the thread cutting that does not have oscillation.

6. The control device according to claim 1, further comprising:
a machining accuracy determination unit configured to determine a level of machining accuracy, wherein
the thread cutting command generation unit
sets a value for the margin that corresponds to the level of machining accuracy determined by the machining accuracy determination unit.

7. The control device according to claim 2, further comprising:
a machining accuracy determination unit configured to determine a level of machining accuracy, wherein
the thread cutting command generation unit
sets a value for the margin that corresponds to the level of machining accuracy determined by the machining accuracy determination unit.

8. The control device according to claim 3, further comprising:
a machining accuracy determination unit configured to determine a level of machining accuracy, wherein
the thread cutting command generation unit
sets a value for the margin that corresponds to the level of machining accuracy determined by the machining accuracy determination unit.

9. The control device according to claim 4, further comprising:
a machining accuracy determination unit configured to determine a level of machining accuracy, wherein
the thread cutting command generation unit
sets a value for the margin that corresponds to the level of machining accuracy determined by the machining accuracy determination unit.

10. The control device according to claim 5, further comprising:
a machining accuracy determination unit configured to determine a level of machining accuracy, wherein
the thread cutting command generation unit
sets a value for the margin that corresponds to the level of machining accuracy determined by the machining accuracy determination unit.
